(19) United States
(12) Patent Application Publication
(10) Pub. No.: US 2021/0236252 A1
(43) Pub. Date: Aug. 5, 2021

(54) INTERDENTAL CLEANING TOOL

(71) Applicant: KOBAYASHI PHARMACEUTICAL CO., LTD., Osaka-shi, Osaka (JP)

(72) Inventor: Tasuku KIKKAWA, Ibaraki-shi (JP)

(73) Assignee: KOBAYASHI PHARMACEUTICAL CO., LTD., Osaka-shi, Osaka (JP)

(21) Appl. No.: 17/050,513

(22) PCT Filed: Apr. 26, 2019
(86) PCT No.: PCT/JP2019/017965

§ 371 Date: Oct. 26, 2020

(30) Foreign Application Priority Data
Apr. 27, 2018 (JP) 2018-087030

(51) Int. Cl. A61C 15/02

(52) U.S. Cl. CPC A61C 15/02

(57) ABSTRACT

Provided is an interdental cleaning tool that can reduce at least one of a resistance against insertion in an interdental space and a resistance against withdrawal from an interdental space, and has a high capability of scraping out deposit from an interdental space. The interdental cleaning tool includes a base portion including a shaft portion (20) and a cleaning portion (40). The cleaning portion (40) includes a cleaning portion body (50) and a plurality of bristles (60). The plurality of bristles (60) include at least one of a type of top end-oriented bristles and a type of base end-oriented bristles. The top end-oriented bristle has a shape titling to a top end side of the shaft portion (20) as advancing away from an outer circumferential surface of the cleaning portion body (50). The base end-oriented bristle has a shape tilting to a base end side of the shaft portion (20) as advancing away from the outer circumferential surface of the cleaning portion body (50).

### TECHNICAL FIELD

The present invention relates to an interdental cleaning tool.

### BACKGROUND ART

Conventionally, an interdental cleaning tool for cleaning an interdental space is known. For example, Patent Literature 1 discloses an interdental cleaning tool including a base structure portion made of synthetic resin, and a soft portion made of elastomer. The base structure portion includes a core base structure portion having a shape insertable in an interdental space, and a handling base structure portion having a shape that can be held by fingers. The soft portion includes a covering portion that covers an outer circumferential surface of the core base structure portion, and a plurality of protruding portions each provided on an outer circumferential surface of the covering portion. Each of the protruding portions has a shape extending outward from the outer circumferential surface of the covering portion in a direction perpendicularly intersecting an axial direction of the core base structure portion.

### CITATION LIST

### Patent Literature

Patent Literature 1: WO 2013/176297 A

In the interdental cleaning tool described in Patent Literature 1, there have been the needs of enhancing the capability of scraping out deposits from an interdental space. Therefore, it has been considered to make protruding portions larger or give a higher rigidity to them. However, the employment of such configuration causes an increased resistance when inserting the tool in the interdental space or withdrawing the tool from the interdental space.

Further, in the interdental cleaning tool described in Patent Literature 1, there have been the needs of improving capability of cleaning (scraping) an interdental space and enhancing operability.

In particular, in the case of a relatively small interdental space, there is a likelihood that a covering portion cannot be inserted in the interdental space by its entire length. There is a room for improvement in operability of the interdental cleaning tool in such a case. Specifically, in the case of a relatively small interdental space, it is difficult to adjust the force to insert and withdraw the interdental cleaning tool in an axial direction. An excessive force is likely to damage the top end portion while a decreased force is likely to maintain the sufficient cleaning capability. Thus, there is a difficulty in operating the interdental cleaning tool properly while keeping or improving the capability of cleaning the interdental space.

### SUMMARY OF THE INVENTION

An object of the present invention is to provide an interdental cleaning tool that can reduce at least one of the resistance against insertion in an interdental space and the resistance against withdrawal from an interdental space, and has a high capability of scraping out deposit from an interdental space.

Another object of the present invention is to provide an interdental cleaning tool that can be operated properly while keeping or improving the capability of cleaning an interdental space.

To solve the problem described above, the present invention provides an interdental cleaning tool including: a base portion including a shaft portion having a shape insertable in an interdental space: and a cleaning portion that covers at least a portion of the shaft portion and is capable of cleaning an interdental space, in which the cleaning portion includes a cleaning portion body that covers at least a portion of the shaft portion, and a plurality of bristles each having a shape protruding outward from an outer circumferential surface of the cleaning portion body, and the plurality of bristles include at least one of a type of top end-oriented bristles having a shape tilting to a top end side of the shaft portion as advancing away from the outer circumferential surface of the cleaning portion body, and a type of base end-oriented bristles having a shape tilting to a base end side of the shaft portion as advancing away from the outer circumferential surface of the cleaning portion body.

Since the plurality of bristles of the interdental cleaning tool includes at least one of the type of top end-oriented bristles and the type of base end-oriented bristles, at least one of the resistance against insertion of the cleaning portion in the interdental space and the resistance against withdrawal of the cleaning portion from the interdental space can be reduced, and the capability of the cleaning portion of scraping out deposit from the interdental space can be raised. Specifically, the top end-oriented bristle causes a high resistance against insertion in the interdental space while having a high capability of scraping out deposit during insertion in the interdental space, and causes a low resistance against withdrawal from the interdental space, compared to a conventional bristle having a shape protruding from an outer circumferential surface of a cleaning portion body in a direction perpendicularly intersecting an axial direction of a shaft portion (hereinafter referred to as “non-tilted bristle”). Meanwhile, the base end-oriented bristle causes a high resistance against withdrawal from the interdental space, but has a low resistance against insertion in the interdental space and has a high capability of scraping out deposit during withdrawal from the interdental space, compared to the conventional non-tilted bristle.

Each of the plurality of bristles may be the type of base end-oriented bristle.

In the configuration, both reduction in the resistance against insertion in the interdental space and improvement in the scraping out capability during withdrawal from the interdental space can be achieved.

Alternatively, the plurality of bristles may include the type of top end-oriented bristles and the type of base end-oriented bristles, and the type of top end-oriented bristles and the type of base end-oriented bristles may alternately be arranged along the axial direction of the shaft portion from the top end side to the base end side of the shaft portion.

The cleaning portion of the interdental cleaning tool may be preferably made of a composite material containing elastomer and a reinforcing material.

In this way, the bristles are given a higher rigidity than a case where the cleaning portion is made only of elastomer. Accordingly, side surfaces of the teeth can effectively be cleaned.

According to another aspect of the present invention, an interdental cleaning tool includes: a base portion extending in a specific direction and including a shaft portion having a shape insertable in an interdental space: and a cleaning portion that is made of a material having a hardness lower than a hardness of the base portion, covers at least a portion of the shaft portion, and is capable of cleaning an interdental space. The cleaning portion includes a cleaning portion body covering an outer peripheral surface of the shaft portion, and is formed with a spiral groove running around an axis along the specific direction.

The present invention can provide, as described above, an interdental cleaning tool that can reduce at least one of a resistance caused when inserting the interdental cleaning tool in an interdental space and a resistance caused when withdrawing the interdental cleaning tool from an interdental space, and has a high capability of scraping out deposit from an interdental space.

Further, the present invention can provide an interdental cleaning tool that can keep or improve the capability of cleaning an interdental and has a proper operationality by forming a cleaning portion body with a spiral groove.

### BRIEF DESCRIPTION OF DRAWINGS

FIG. 1 is a front view of an interdental cleaning tool according to a first embodiment of the present invention.

FIG. 2 is an enlarged view of a cleaning portion of the interdental cleaning tool illustrated in FIG. 1.

FIG. 3 is a plan view of the interdental cleaning tool illustrated in FIG. 1.

FIG. 4 is a front view illustrating an interdental cleaning tool according to a second embodiment of the present invention.

FIG. 5 is a perspective view illustrating a top end portion of the interdental cleaning tool illustrated in FIG. 4 in an enlarged manner.

FIG. 6 is a longitudinally cross sectional view taken along a line 111-111 in FIG. 4.

FIG. 7 is a longitudinally cross sectional view illustrating a groove formed in the interdental cleaning tool illustrated in FIG. 4 in an enlarged manner.

FIG. 8 is a longitudinally cross sectional view taken along a line V-V in FIG. 4.

FIG. 9 is an enlarged longitudinally cross sectional view of a modified interdental cleaning tool, corresponding to FIG. 7.

FIG. 10 is an enlarged cross sectional view of an interdental cleaning tool according to a third embodiment of the present invention, corresponding to FIG. 8.

### DESCRIPTION OF EMBODIMENTS

### First Embodiment

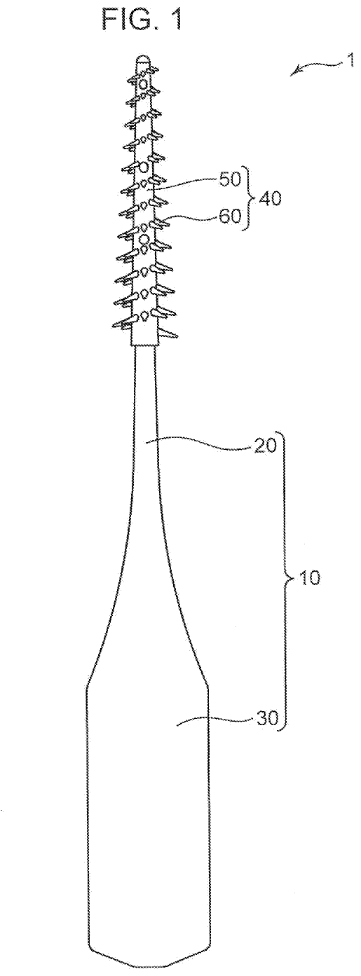

An interdental cleaning tool 1 according to a first embodiment of the present invention will be described with reference to FIGS. 1 to 3. As illustrated in FIG. 1, the interdental cleaning tool 1 includes a base portion 10, and a cleaning portion 40.

The base portion 10 is made of a synthetic resin such as polypropylene, polyethylene, ABS, polybutylene terephthalate, polycarbonate, polyethylene terephthalate, polystyrene, and polyacetal. In the embodiment, the base portion 10 is made of polypropylene containing glass fibers by 30% by weight. The base portion 10 includes a shaft portion 20, and a grip portion 30.

The shaft portion 20 has a shape extending straight in a specific direction (up-and-down direction in FIG. 1) and insertable in an interdental space. The shaft portion 20 has a shape whose cross sectional size of the shaft portion 20 in a plane perpendicularly intersecting an axial direction of the shaft portion 20 (the up-and-down direction in FIG. 1) gradually increases along a direction from a top end side to a base end side (opposite the top end side) of the shaft portion 20. In the embodiment, the cross section of the shaft portion 20 in the plane is a circle. In other words, in the embodiment, the shaft portion 20 has a form of a column of which outer diameter gradually decreases from a base end portion to a top end portion of the shaft portion 20. The cross section of the shaft portion 20 may be an oval shape or a polygonal shape.

The grip portion 30 extends in the axial direction of the shaft portion 20 away from the base end portion of the shaft portion 20 and has a shape that can be held by fingers. The grip portion 30 is formed into a flat shape.

The cleaning portion 40 is adapted for cleaning an interdental space and side surfaces of teeth. The cleaning portion 40 is made of a resin material having a lower hardness than the base portion 10. Specifically, styrene elastomer is used as the resin material. Other materials, such as silicone, olefinic elastomer, and polyester elastomer, may also be used as the resin material. The cleaning portion 40 includes a cleaning portion body 50, and a plurality of bristles 60.

The cleaning portion body 50 covers at least a portion of the shaft portion 20 (the portion including the top end portion of the shaft portion 20). The cleaning portion body 50 has a shape whose profile gradually increases along the direction from the top end side to the base end side of the shaft portion 20.

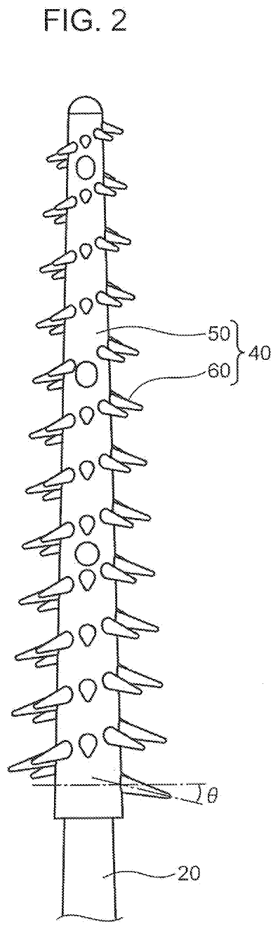

Each of the bristles 60 is provided on an outer circumferential surface of the cleaning portion body 50. The bristle 60 has a shape protruding outward from the outer circumferential surface of the cleaning portion body 50 in an intersecting direction that intersects the axial direction. In the embodiment, the bristle 60 has the shape of a cone. Each of the bristles 60 is a base end oriented having a shape tilting to the base end side (lower side in FIG. 2) of the shaft portion 20 as advancing away from the outer circumferential surface of the cleaning portion body 50. As illustrated in FIG. 2, a tilt angle θ of the base end oriented (angle between a plane perpendicularly intersecting the axial direction of the shaft portion 20 and a direction in which the base end-oriented bristle protrudes from the cleaning portion body 50) is preferably set at a degree of 1 or more and 70 or less, more preferably at 5 or more and 45 or less, furthermore preferably at 10 or more and 30 or less, and particularly preferably at 15 or more and 20 or less. The direction in which the base end-oriented bristle protrudes from the cleaning portion body 50 is the direction along the axis of the base end-oriented bristle.

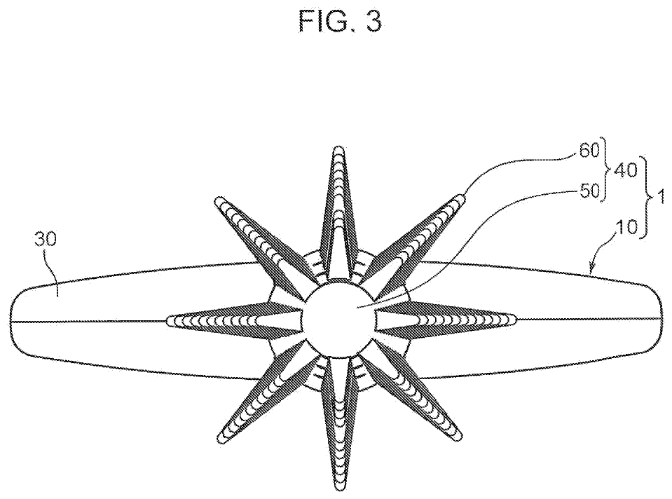

The bristles 60 have respectively such shapes that their protruding lengths from the cleaning portion body 50 gradually increase along the direction from the top end side to the base end side of the shaft portion 20. As illustrated in FIG. 3, the bristles 60 are provided at positions spaced from one another along a circumferential direction of the cleaning portion body 50 in a plan view. Specifically, the bristles 60 are arranged at an interval of 45 degrees along the circumferential direction.

As described above, since the plurality of bristles 60 of the interdental cleaning tool 1 are the base end-oriented bristles, the resistance against insertion of the cleaning portion 40 in the interdental space can be reduced and at the same time the capability of scraping out deposit from the interdental space during the withdrawal of the cleaning portion 40 can be raised. Specifically, the base end-oriented bristle causes a high resistance against withdrawal from the interdental space while causing a low resistance against insertion in the interdental space, but has an increased capability of scraping out deposit during withdrawal from the interdental space, compared to a conventional bristle having a shape protruding from an outer circumferential surface of a cleaning portion body in a direction perpendicularly intersecting an axial direction of a shaft portion (hereinafter referred to as “non-tilted bristle”).

Note that the embodiment disclosed above should be considered as illustrative in all aspects and not by means of limitation. The scope of the present invention is defined by the claims, not by the description on the embodiment described above, and includes all alterations within the scope of the meanings equivalent to the claims and within the scope of the claims.

For example, a plurality of bristles 60 may each be a type of top end-oriented bristles having a shape tilting to a top end side of the shaft portion 20 as advancing away from the outer circumferential surface of the cleaning portion body 50. In this configuration, the resistance against withdrawal of the cleaning portion 40 from the interdental space can be reduced and the capability of scraping out deposit from the interdental space during insertion of the cleaning portion 40 can be raised. Specifically, the top end-oriented bristle causes a high resistance against insertion in the interdental space while having a high capability of scraping out the deposit during insertion in the interdental space, and causes a low resistance against withdrawal from the interdental space, compared to the non-tilted bristle.

Furthermore, a plurality of bristles 60 may include both the type of top end-oriented bristles and the type of base end-oriented bristles. In this case, the type of top end-oriented bristles and the type of base end-oriented bristles may alternately be arranged along the axial direction from the top end side to the base end side of the shaft portion 20.

Furthermore, respective tilt angles θ of the bristles 60 may not be set at the same. For example, their respective tilt angles θ may be set so as to be smaller along the direction from the top end side to the base end side of the cleaning portion body 50.

Each of the bristles 60 may have the shape of a polygonal pyramid or a plate (flat shape).

The cleaning portion 40 may be made of a composite material containing a resin material and a reinforcing material (for example, glass fibers or talc). In this way, the bristles 60 are each given a higher rigidity than a case where the cleaning portion 40 is made only of elastomer. Accordingly, side surfaces of teeth can effectively be cleaned. In this case, the composite material preferably contains the reinforcing material by 3% by weight to 50% by weight, inclusive, more preferably 5% by weight to 35% by weight, inclusive.

### Second Embodiment

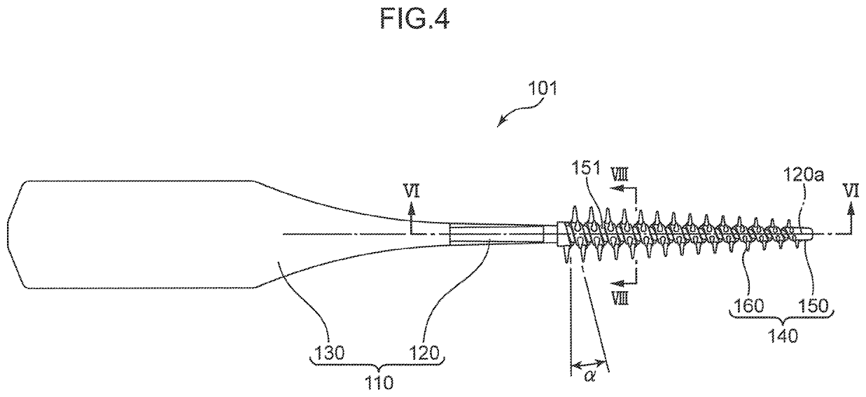

An interdental cleaning tool 101 according to a second embodiment of the present invention will be described with reference to FIGS. 4 to 8. FIG. 4 illustrates a front view of the interdental cleaning tool 101.

The interdental cleaning tool 101 includes a base portion 110 made of a synthetic resin, and a cleaning portion 140 that is provided on the base portion 110 and is made of a material having a hardness lower than a hardness of the synthetic resin.

The base portion 110 includes a shaft portion 120, and a grip portion 130. The base portion 110 is integrally made of a synthetic resin such as polypropylene, polyethylene, ABS, polybutylene terephthalate, polycarbonate, polyethylene terephthalate, polystyrene, polyacetal, and polyamide. In the embodiment, the base portion 110 is made of polypropylene containing glass fibers at 30% by weight.

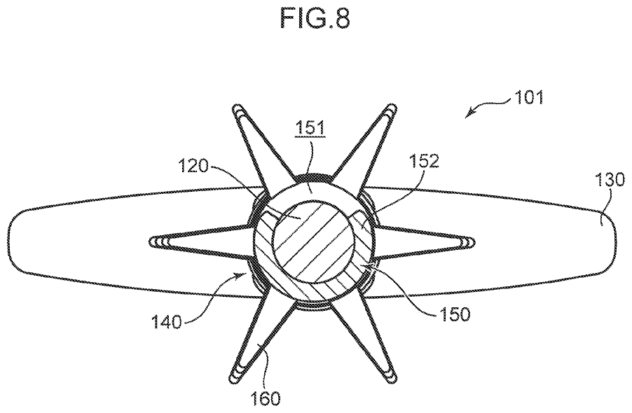

The shaft portion 120 has a shape which linearly extends in a specific direction (left-and-right direction in FIG. 4) and whose top end portion is at least insertable in an interdental space. Specifically, the shaft portion 120 has an axis 120a extending in the specific direction, and one end (right end in FIG. 4) of the shaft portion 120 is formed with the top end portion, and the other end of the shaft portion 120 is formed with a base end portion. The shaft portion 120 has a slanting contour of which profile gradually becomes larger along the direction from the insertable top end portion to the base end portion. In the embodiment, a cross section (hereinafter referred to as “axis orthogonal cross section”) of the shaft portion 120 in a plane perpendicularly intersecting the direction along the axis 120a of the shaft portion 120 (hereinafter referred to as “axial direction”) has a circular shape as illustrated in FIG. 8. In this embodiment, a maximum diameter of the portion of the shaft portion 120 that is to be inserted in the interdental space is preferably set at 3.0 mm or less, more preferably at 1.0 mm or less, to ensure inserting in the interdental space.

The grip portion 130 continues from the base end portion of the shaft portion 120, extends along the axial direction of the shaft portion 120 away from the base end portion of the shaft portion 120, and has a shape that can be held by fingers. The grip portion 130 has a shape of a flat plate. Specifically, the dimension of the grip portion 130 that is in a second direction (left-and-right direction in FIG. 8) perpendicularly intersecting both the specific direction (axial direction) and a first direction (up-and-down direction in FIG. 8) perpendicularly intersecting the specific direction is larger than the dimension of the grip portion 130 that is in the first direction. The dimension of the grip portion 130 that is in the first direction (the up-and-down dimension in FIG. 8) is set larger than the diameter of the shaft portion 120.

The cleaning portion 140 is adapted for cleaning the interdental space and made of a material having a lower hardness than the base portion 110. In this embodiment, the material is a composite material containing elastomer and a reinforcing material. Specifically, a styrene elastomer is used in this embodiment. However, silicone, olefinic elastomer, or polyester elastomer may be used. Glass fibers are used as the reinforcing material in this embodiment. However, carbon fibers, synthetic fibers such as aramid, natural fibers such as cellulose, silica particles, carbon black, talc, or the like may be used. In the viewpoint of improving the resilience of the cleaning portion 140, the composition amount of the reinforcing material relative to the elastomer is preferably 1% by weight or higher, more preferably 2% by weight or higher. Meanwhile, in the view point of formability and elasticity of the cleaning portion 140, the composition amount of the reinforcing material relative to the elastomer is preferably 50% by weight or lower, more preferably 30% by weight or lower. The hardness of the material of the cleaning portion 140 is preferably from 1 to 60 in the term of type-A durometer (JIS K 6253), more preferably from 10 to 40. In this embodiment, the cleaning portion has 35 in the term of type-A durometer. Further, it should be noted that elastic material such as elastomer and foamed synthetic resin may be singly used as the material for the cleaning portion 140.

Specifically, the cleaning portion 140 includes a cleaning portion body 150, and a plurality of bristles 160.

The cleaning portion body 150 has a shape that covers at least a portion of an outer peripheral surface of the shaft portion 120 (the portion including the insertable top end portion). In this embodiment, the cleaning portion body 150 has a slanting contour expanding outward in a direction perpendicularly intersecting the axis 120a from the top end side to the base end side. A slope angle of the cleaning portion body 150 is set at approximately identical to a slope angle of the shaft portion 120 so that the thickness of the cleaning portion body 150 is uniform (or substantially uniform).

In this embodiment, the axis orthogonal cross section of the cleaning portion body 150 has a circular shape and a uniform thickness of 0.2 mm.

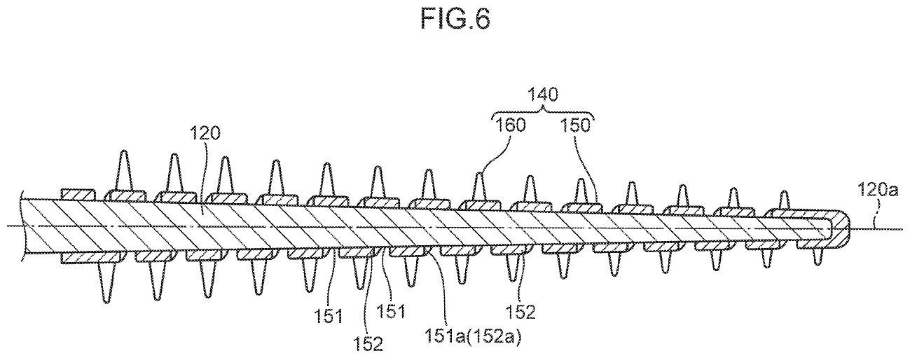

The cleaning portion body 150 is formed with a spiral groove 151 running around the axis 120a of the shaft portion 120. There is a section of a thread ridge 152 between sections of the groove 151 on an axially cross sectional plane (FIG. 6) bearing the axis 120a. In this embodiment, the cleaning portion body 150 has an external shape like a square thread in which the thread ridge 152 having a rectangularly slender shape extending in a direction is provided on at a constant pitch and a substantially uniform height.

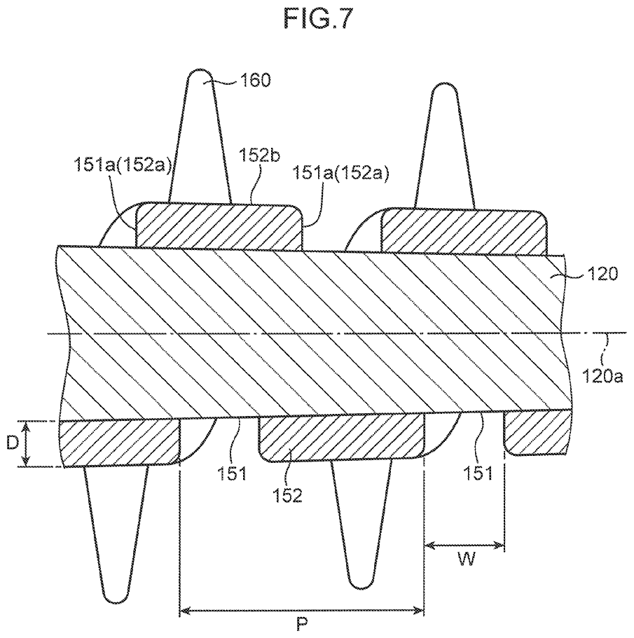

Specifically, the groove 151 is formed in the way of right-handed spiral from the top end portion to the base end portion of the cleaning portion body 150. A groove bottom of the groove 151 is the outer peripheral surface of the shaft portion 120. As illustrated in FIG. 7, side wall surfaces 151a of the groove 151 rise perpendicular (or substantially perpendicular) to the axis 120a on the axially cross sectional plane bearing the axis 120a of the shaft portion 120 (FIG. 6).

The pitch P of the groove 151 is preferably set within a range from 0.3 mm or more to 3.0 mm or less, more preferably within a range from 0.5 mm or more to 1.5 mm or less. In this embodiment, the constant pitch P is set at 1.0 mm. In a case where the pitch P of the groove 151 is too small, the capability of catching plaque or the like lowers. On the other hand, in the case of too large, the capability of cleaning the interdental space lowers. It is preferable that the pitch P is set a proper one within the range described above. Note that the pitch P of the groove 151 is not limited to a constant pitch as in this embodiment, but the pitch may be set at a non-constant pitch that gradually increases or decreases from the top end side of the cleaning portion body 150 along the axis 120a.

The depth D of the groove 151 (height of the thread ridge 152) is preferably set within a range from 0.01 mm or more to 2.00 mm or less, more preferably within a range from 0.10 mm or more to 1.00 mm or less. In this embodiment, the depth H of the groove 151 is substantially uniformly at 0.2 mm throughout the entire length. In the case where the depth D of the groove 151 is too small, the capability of catching plaque or the like and the screwing effect lower. On the other hand, in the case of too large, the thread ridge 152 is likely to bend to lower the cleaning capability. It is preferable that the depth D is set at a proper one within the range described above. Note that, the depth D of the groove 151 is not limited to a constant depth throughout substantially the entire length as in this embodiment. The depth D may change gradually or stepwise along the direction from the top end side to the base end side of the cleaning portion body 150.

A lead angle α of the groove 151 is preferably set within a range from 15 degrees or more to 35 degrees or less, more preferably within a range from 20 degrees or more to 30 degrees or less. In this embodiment, the lead angle α of the groove 151 is set at 27 degrees.

An open width W of the groove 151 (dimension in the axial direction) is suitably set considering the diameter of the shaft portion 120 and the pitch P and the lead angle α of the groove 151. In this embodiment, the open width W is set to be smaller than the width (dimension in the axial direction) of the thread ridge 152.

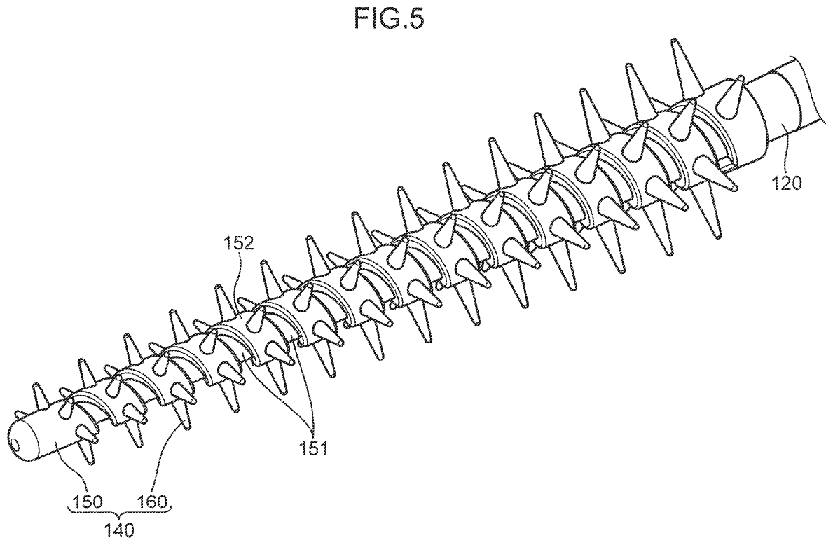

By forming the groove 151 in the cleaning portion body 150 as described above, the thread ridge 152 comes to exist in the form of a spiral band provided around the shaft portion 120 as illustrated in FIG. 5. As described above, the thread ridge 152 runs between turns of the groove 151 on the axially cross sectional plane bearing the axis 120a. As clearly illustrated in FIG. 7, the thread ridge 152 includes a flank 152a which is a side wall surface 151a of the groove 151, and a ridge top surface 152b interconnecting tops of adjacent flanks 152a. In this embodiment, a portion between the flank 152a and the ridge top surface 152b is rounded into an arc shape. In this embodiment, the ridge top surface 152b runs along the outer peripheral surface of the shaft portion 120 on the axially cross sectional plane bearing the axis 120a.

Meanwhile, each of the bristles 160 is provided on an outer peripheral surface of the cleaning portion body 150 other than the groove 151, that is, on the ridge top surface 152b of the thread ridge 152. Specifically, each of the bristles 160 are arranged on the ridge top surface 152b in a single spiral along the groove 151 of the cleaning portion body 150. Each of the bristles 160 has a shape protruding outward from the ridge top surface 152b in a direction intersecting the axial direction of the shaft portion 120. The bristles 160 are formed so as to gradually increase their protruding dimensions as advancing to bristles 160 disposed in the base end side of the cleaning portion body 150 from bristle 160 disposed in the top end side of the cleaning portion body 150. In this embodiment, the bristles 160 each have a conical shape protruding in a direction perpendicularly intersecting the axial direction of the shaft portion 120 and are disposed in a plurality of radial directions (six directions, in FIG. 8) from the shaft portion 120 at the center. The bristles 160 of this embodiment are integrally formed with the cleaning portion body 150 by injection forming.

A using manner of the interdental cleaning tool 101 of this embodiment will be described together with operational effects. A user holds the interdental cleaning tool 101 by the grip portion 130 of the base portion 110 and inserts the cleaning portion 140 in the interdental space from the top end side of the shaft portion 120. The cleaning portion body 150 slanting toward the top end side improves the insertion capability in the interdental space. By moving the interdental cleaning tool 101 linearly back and forth along the axial direction of the shaft portion 120, the interdental space is cleaned by the cleaning portion 140.

Specifically, by operating the interdental cleaning tool 101 linearly back and forth along the axial direction of the shaft portion 120, the flank 152a (the side wall surface 151a of the groove 151) of the thread ridge 152 scrapes out plaque and food debris from the interdental space and the bristle 160 protruding from the ridge top surface 152b scrapes off plaque or the like from corners of the interdental space. The scraped out or scraped off plaque or the like are discharged out of the interdental space by the linear back-and-forth operation, and at least a portion of the plaque or the like is caught in the groove 151 of the cleaning portion body 150. This minimizes the plaque and food debris remaining in the oral cavity after the cleaning portion 140 is withdrawn out from the interdental space.

Meanwhile, in the case where the interdental cleaning tool 101 is likely to be caught in a narrow interdental space while being operated linearly back and forth, the base portion 110 is rotated in a right-hand direction after the cleaning portion 140 is inserted to a position where the interdental cleaning tool 101 is caught. In the interdental cleaning tool 101 of this embodiment, the cleaning portion body 150 is formed with the groove 151 in the right-handed spiral about the axis 120a in which the shaft portion 120 extends, and the thread ridge 152 is formed between turns of the groove 151. Accordingly, the cleaning portion 140 can be screwed into the interdental space by a proper operating force by the rotational operation. Moreover, the cleaning portion body 150 is made of the composite material having a hardness lower than that of the base portion 110. Thus, even if an excessive pushing force is applied to the cleaning portion body 150, the thread ridge 152 between the turns of the groove 151 bends to cause the interdental cleaning tool to resistlessly rotate, which can effectively suppress troubles such as damages by an unintended operating force. In addition, the resistless rotation scrapes out plaque or the like by the bristle 160 and the thread ridge 152, and causes them to be effectively caught in the groove 151 and discharged out of the interdental space by the conveying effect of the spiral groove 151. Furthermore, the catching of the plaque or the like in the groove 151 minimizes plaque and food debris remaining in the oral cavity after the cleaning portion 140 is withdrawn out from the interdental space, in similar to the case of the linear back-and-forth operation. In other words, the interdental cleaning tool 101 can be operated properly while keeping or improving the capability of cleaning the interdental space.

In the interdental cleaning tool 101, the side wall surface 151a of the groove 151, in other words, the flank 152a of the thread ridge 152, rises perpendicular to the axis 120a on the axially cross sectional plane bearing the axis 120a. Accordingly, the effect of scraping out plaque or the like by the conveying effect of the groove 151 which is generated by the resistless rotation of the interdental cleaning tool 101 can be improved not only in the linear back-and-forth operation of the interdental cleaning tool 101 but also in the rotational operation of the interdental cleaning tool 101. In other words, the capability of cleaning the interdental space can be improved regardless of the way of operating the interdental cleaning tool 101.

Moreover, since the groove bottom of the groove 151 is the outer peripheral surface of the shaft portion 120, the groove 151 can be defined as deep as possible, which thus can improve not only the cleaning capability but the capability of catching plaque or the like in the groove 151. In addition, since the material is different between the thread ridge 152 and the groove bottom of the groove 151, the rubbing effect on the gum can be improved by the linear back-and-forth operation or the rotational operation of the interdental cleaning tool 101.

In the manufacturing process of the interdental cleaning tool 101 of this embodiment, the base portion 110 including the shaft portion 120 is formed in a primary forming, and then the cleaning portion 140 is formed on the shaft portion 120 by injection forming in a secondary forming. In the secondary forming, the die coming to contact with the groove bottom of the groove 151 reliably suppresses a shift of the shaft portion 120 which is likely to happen when resin for forming the cleaning portion 140 is injected. Accordingly, the cleaning portion body 150 can be formed at a further uniform thickness.

Furthermore, the cleaning portion 140 includes the plurality of bristles 160 protruding outward from the ridge top surface 152b of the thread ridge 152 in the radial directions of the cleaning portion body 150 and the bristles 160 are arranged in the single spiral along the groove 151. Thus, the capability of cleaning the interdental space can be improved by the linear back-and-forth operation or the rotational operation of the interdental cleaning tool 101. Moreover, the spirally formed groove 151 can be easily seen from the outside, which enables the user to intuitively perceive the conveying effect of the groove 151 in a situation where the interdental cleaning tool 101 is displayed or used.

Furthermore, the cleaning portion 140 made of a composite material including elastomer and the reinforcing material has the high resilience compared to the cleaning portion 140 made of elastomer only. Accordingly, the discharging effect caused by the conveying effect of the groove 151 can be enhanced. In particular, since the plurality of bristles 160 provided on the cleaning portion 140 have the high resilience, the side surfaces of the teeth can effectively be cleaned.

It should be noted that the embodiments disclosed above should be considered as illustrative in all aspects and not by means of limitation. The scope of the present invention is defined by the claims, not by the description on the embodiment described above, and includes all alterations within the scope of the meanings equivalent to the claims and within the scope of the claims. For example, an interdental cleaning tool according to the present invention may be configured as below.

(1) In the second embodiment described above, the side wall surface 151a of the groove 151 of the cleaning portion body 150 perpendicularly rises on the axially cross section plane bearing the axis 120a. However, the form of the groove of the cleaning portion body 150 is not limited to such a configuration. For example, the side wall surface 151a of the groove 151 may be inclined to the side of the groove 151 or to the opposite side to the groove 151 on the axially cross sectional plane bearing the axis 120a as the side wall surface 151a extends outward with respect to the axis 120a. Further, the thread ridge 152 may be formed with a side wall surface (flank) in the top end side and a side wall surface (flank) in the base end side which have different inclination angles from each other.

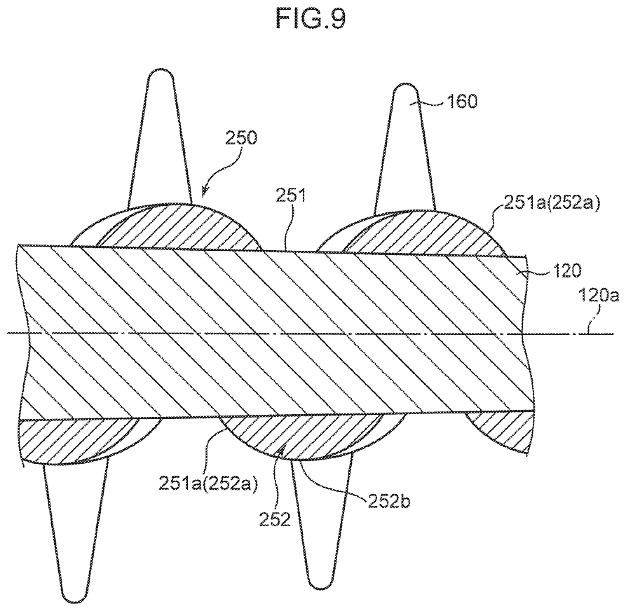

There is an occasion that the thread ridge 152 is formed to a different shape when the shape of the groove 151 is changed. The shape of the thread ridge 152 is not limited to the square thread. For example, the thread ridge 252 may be formed to a round thread as illustrated in FIG. 9. In this case, a groove 251 of a cleaning portion body 250 has a side wall surface 251a having a curved line on the axially cross sectional plane, and the thread ridge 252 has a flank 252a and ridge top surface 252b which are connected with each other. The specific shape of the thread ridge is not limited to a specific one as long as the thread ridge has a shape that causes a screwing effect, a triangular shape, a trapezoid shape or the like. In the case where the thread ridge 152 is a square thread as in the above-mentioned second embodiment, the side wall surface 151a of the groove 151 can efficiently scrape out plaque or the like, and the cleaning capability can be improved.

(2) In the second embodiment, the entire length of the groove bottom of the groove 151 of the cleaning portion body 150 is defined by the outer peripheral surface of the shaft portion 120. However, the groove bottom may be raised in a specific portion or the entire portion thereof by forming the groove bottom in the cleaning portion body.

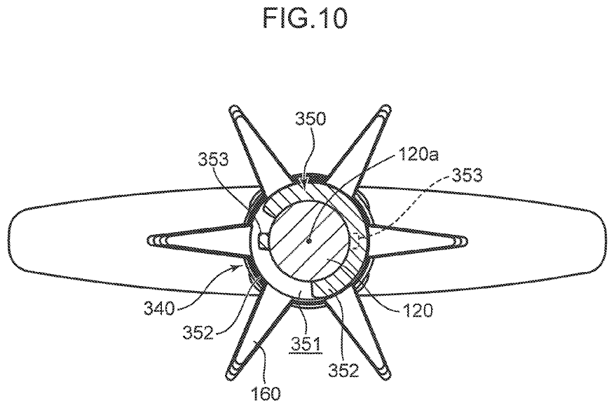

For example, FIG. 10 illustrates a transverse cross sectional view of a third embodiment where a bottom of the groove 251 is partially and intermittently raised.

Specifically, a cleaning portion body 350 of a cleaning portion 340 is formed with a spiral groove 351, a thread ridge 352, and scraping projections 353 intermittently provided in the groove 351. Although not shown in the figure, the scraping projection 353 interconnects the opposite side wall surfaces of the thread ridge in the direction of the axis 120a on the axially cross sectional plane. The scraping projection 353 protrudes outward from the outer peripheral surface of the shaft portion 120 in a radial direction of the shaft portion 120, and the protruding height is set to be as large as or smaller than that of the thread ridge 352. Furthermore, the scraping projections 353 are provided radially from the shaft portion 120 at the center on the axis orthogonal cross section. In FIG. 10, a pair of scraping projections 353 protruding in the left and right directions are provided.

The interdental cleaning tool according to the third embodiment has the same effects as the second embodiment described above. Further, the scraping projection 353 can efficiently scrape out plaque and food debris from the side surface of the teeth by rotating the tool, thereby generating an improved effect to the cleaning capability.

(3) In the second embodiment described above, the shaft portion 120 is a solid cone. However, the form of the shaft portion of the base portion is not limited to such a configuration, but may be formed into a polygonal pyramid including a triangular pyramid, a circular column, or a polygonal column including a triangular column. Alternatively, the shaft portion 120 may be formed with a spiral shaft groove running around the axis 120a and continuing to the corresponding groove 151 of the cleaning portion body 150 to thereby form a deeper spiral groove. The provision of the spiral shaft groove in the shaft portion 120 as described above increases the depth of the spiral groove of the interdental cleaning tool to improve the capability of catching plaque or the like while preventing degradation in the cleaning capability caused by deformation of the thread ridge.

(4) In the second embodiment described above, the groove 151 of the cleaning portion body 150 is formed in a spiral like a single right-handed screw. However, the groove may be formed in a left-handed spiral or a plurality of spiral grooves like a double threaded screw.

(5) In the second embodiment, the external shape of the cleaning portion body 150 is a slanting shape expanding outward in the radial direction of the shaft portion 120 along the direction from the top end side to the base end side. However, the external shape of the cleaning portion body is not limited to the specific configuration. For example, the external shape may be a cylinder shape, a gourd shape, or a drum shape.

(6) In the second embodiment, the profile of the cleaning portion body 150 in the axis orthogonal cross section is a circle. Although the specific shape in the axis orthogonal cross section may be an oval shape, a polygonal shape, or the like, the shape may preferably have a bilateral symmetry about the axis 120a, more preferably the shape is circular as in the second embodiment described above. This is because, when the interdental cleaning tool 101 is rotationally operated, the cleaning performance is delivered uniformly along the circumferential direction at the same position with respect to the axial direction, thereby providing a stable cleaning capability.

In summary, the interdental clearing tool is worked out owing to the fact that the inventors have studied intensively to solve the problems described above, and found that: conventional interdental cleaning tools are concentratedly operated linearly in an axial direction to clean an interdental space, which consequently causes damage or like in the case of applying an operating force directly to the interdental cleaning tool when the interdental cleaning tool is caught in the process of operating the interdental cleaning tool in a relatively narrow interdental space which makes insertion and withdrawal of the cleaning portion body by its entire length difficult, for example. The inventors have conceived that the problem described above can be solved by rotating the interdental cleaning tool, not linearly operating the interdental cleaning tool in the axial direction when the interdental cleaning tool is caught in the interdental space.

Accordingly, the interdental cleaning tool comprises: a base portion extending in a specific direction and including a shaft portion having a shape insertable in an interdental space; and a cleaning portion that is made of a material having a hardness lower than a hardness of the base portion, covers at least a portion of the shaft portion, and is capable of cleaning an interdental space. The cleaning portion includes a cleaning portion body covering an outer peripheral surface of the shaft portion, and is formed with a spiral groove running around an axis along the specific direction.

The cleaning portion body of the interdental cleaning tool is formed with the spiral groove running around the axis along the specific direction. Accordingly, when the interdental cleaning tool is caught in the interdental space, the interdental cleaning tool can be screwed into the interdental space at a suitable operating force by rotating the base portion. Moreover, the cleaning portion body is made of a material having a hardness lower than that of the base portion. Accordingly, even when an excessive pushing force is applied to the cleaning portion body, the cleaning portion body bends at a portion between groove turns, which consequently allows the interdental cleaning tool to be resistlessly rotated and effectively suppresses troubles such as a damage of the interdental cleaning tool by an unintended operating force. In addition, the resistless rotation removes plaque and food debris which are then discharged out of the interdental space by a conveying effect of the spiral groove. Furthermore, since the plaque or the like is firmly caught in the groove, the plaque and food debris can be kept from remaining in the oral cavity after the cleaning portion is withdrawn out from the interdental space. Thus, the interdental cleaning tool can keep or improve the capability of cleaning the interdental space, and assure the proper operation.

The shape of the groove of the interdental cleaning tool is not limited to a specific one. For example, a side wall surface of the groove may extend to a groove bottom at an inward or outward inclination in a groove width direction to the axis over an axially cross sectional plane bearing the axis. However, it is preferable that the side wall surface of the groove rises perpendicularly to the axis on the axially cross sectional plane bearing the axis. It should be noted that the term “perpendicular” means not only “right angle” but also “substantially perpendicular”, a range from 75 degrees to 105 degrees, preferably a range from 80 degrees to 100 degrees.

This configuration will enhance the effect of discharging plaque or the like by the conveying effect of the groove owing to the resistless rotation when the interdental cleaning tool is rotated. Moreover, even when the interdental cleaning tool is operated linearly along the specific direction, the side wall surface rising perpendicularly to the axis can effectively scrape out plaque or the like. That is, the capability of cleaning the interdental space can be improved regardless of the way of operating the interdental cleaning tool.

The groove bottom of the groove of the interdental cleaning tool is not limited to a specific one. For example, the groove bottom may be formed in a portion of the cleaning portion body. However, it is preferable that the groove bottom of the groove is defined by the peripheral surface of the shaft portion.

With the configuration, the groove may be formed as deep as possible, which can improve not only the cleaning capability but also the capability of catching plaque or the like in the groove. Moreover, since a portion between turns of the groove is different in material from the bottom of the groove, rubbing effect to the gum can be improved by performing the linear operation or the rotational operation of the interdental cleaning tool. It should be understood that in the case that the cleaning portion body is made of a thermoplastic synthetic resin or the like and a secondary processing is applied to the shaft portion, such as injection forming of a cleaning portion body in a manufacturing process, a die comes into contact to the groove bottom of the groove, which consequently reliably enables the shaft portion from shifting due to injected resin. This is advantageous in that the cleaning portion body can be formed with a further uniform thickness.

The cleaning portion of the interdental cleaning tool is not particularly limited to a specific one, and may be configured so as to remove plaque or the like by an outer peripheral surface of the cleaning portion body. However, it is preferable that the cleaning portion further includes a plurality of bristles connected to a portion of the cleaning portion body other than the groove and protruding outward from the portion.

The configuration in which the cleaning portion includes the plurality of bristles in addition to the cleaning portion body will improve the capability of cleaning the interdental space by the linear operation or the rotational operation of the interdental cleaning tool. Furthermore, since the bristles are connected to the portion of the cleaning portion body other than the groove and protrude outward from the cleaning portion body, the bristles can reach corners of the interdental space and thus the cleaning capability is improved compared to a configuration in which bristles are connected to a groove. Moreover, since the bristles are connected to the portion of the cleaning portion body other than the groove, the rotational operation of the interdental cleaning tool can cause the bristle to scrape off plaque or the like from the interdental space and to effectively catch the scraped off plaque or the like in the groove, and to efficiently discharge it out of the interdental space owing to the conveying effect of the groove.

In this configuration, arrangement of the bristles on the cleaning portion body is not particularly limited. However, it is preferable that the bristles are arranged in a single spiral along the groove.

With the configuration, the plaque or the like scraped off by the bristles by the rotational operation of the interdental cleaning tool can be easily caught in the groove, and the plaque or the like caught in the groove can effectively be discharged. Moreover, since the plurality of bristles are arranged in the single spiral along the groove, the spirally formed groove can be easily seen from the outside, which enables the user to intuitively perceive the conveying effect of the groove.

Furthermore, in the interdental cleaning tool, the material may use in single or combination elastomer, foamed soft synthetic resins, or the like as far as having a hardness lower than the base portion. However, it is preferable that the material is a composite material including elastomer and a reinforcing material.

With the configuration, the cleaning portion has a higher resilience than a cleaning portion made only of elastomer. Accordingly, the discharging effect generated by the conveying effect of the groove can be raised. In particular, the cleaning portion including the plurality of bristles can effectively clean side surfaces of teeth by the bristles having the high resilience.

Moreover, the cleaning portion body of the interdental cleaning tool is not limited to a specific external shape, and may have a shape of a cylinder, a gourd, a two head drum. However, it is preferable that the cleaning portion body has a slanting contour expanding outward with respect to the axis from a top end side to a base end side.

With the configuration, the cleaning portion body having the tapered top end can improve the insertion capability in the interdental space. Furthermore, the interdental cleaning tool can be linearly operated along the specific direction until the interdental cleaning tool is caught in the interdental space, and then rotated at a position where the interdental cleaning tool is caught. Accordingly, the interdental cleaning tool can be screwed in by being rotated at a proper sectional size corresponding to a space size between teeth, and be imparted with the conveying effect by the resistless rotation. In other words, the operation of the interdental cleaning tool can be improved by shifting from the linear operation to the rotational operation at a proper position, and the capability of cleaning the interdental space can be improved.

### REFERENCE SIGNS

1 interdental cleaning tool
10 base portion
20 shaft portion
30 grip portion
40 cleaning portion
50 cleaning portion body
60 bristle
101 interdental cleaning tool
110 base portion
120 shaft portion
120a axis
140 cleaning portion
150 cleaning portion body
151 groove
151a side wall surface
160 bristle

1-4: (canceled)

5: An interdental cleaning tool comprising:
a base portion extending in a specific direction and including a shaft portion having a shape insertable in an interdental space; and
a cleaning portion that is made of a material having a hardness lower than a hardness of the base portion, covers at least a portion of the shaft portion, and is capable of cleaning an interdental space, wherein
the cleaning portion includes a cleaning portion body covering an outer peripheral surface of the shaft portion, and
the cleaning portion body is formed with a spiral groove running around an axis along the specific direction.

6: The interdental cleaning tool according to claim 5, wherein a side wall surface of the groove rises perpendicularly to the axis on an axially cross sectional plane bearing the axis.

7: The interdental cleaning tool according to claim 5, wherein a groove bottom of the groove is defined by the outer peripheral surface of the shaft portion.

8: The interdental cleaning tool according to claim 5, wherein the cleaning portion further includes a plurality of bristles connected to the other portion of the cleaning portion body than the groove, and protruding outward from the portion.

9: The interdental cleaning tool according to claim 8, wherein the plurality of bristles are arranged in a spiral along the groove.

10: The interdental cleaning tool according to claim 5, wherein the material is a composite material containing elastomer and a reinforcing material.

11: The interdental cleaning tool according to claim 5, wherein the cleaning portion body has a slanting contour expanding outward with respect to the axis from a top end side to a base end side.
